(19) United States
(12) Patent Application Publication
(10) Pub. No.: US 2014/0204209 A1
(43) Pub. Date: Jul. 24, 2014

(54) TRAFFIC LIGHT DETECTION

(71) Applicant: GM GLOBAL TECHNOLOGY OPERATIONS LLC, Detroit, MI (US)

(72) Inventors: Johannes HUTH, Trebur (DE); Norbert SIMM, Offenbach (DE)

(73) Assignee: GM GLOBAL TECHNOLOGY OPERATIONS LLC, Detroit, MI (US)

(21) Appl. No.: 14/097,740

(22) Filed: Dec. 5, 2013

(30) Foreign Application Priority Data
Dec. 6, 2012 (DE) 10 2012 023 867.3

(51) Int. Cl. H04N 7/18

(52) U.S. Cl. CPC H04N 7/183
USPC 348/148

(57) ABSTRACT

A traffic light detection system is provided that includes, but is not limited to an optical sensor for recording image data of an environment ahead of the vehicle, and an evaluation device for detecting a traffic light mapped in the image data, and an evaluation device for detecting a traffic light mapped in the image data, as well as a method for traffic light detection. The evaluation device is configured to detect a stop line in the image data, which is arranged on a carriageway ahead of the motor vehicle, in a predefined area ahead of a traffic light associated with the carriageway, transversely to the carriage longitudinal direction. The evaluation device includes, but is not limited to a verification device, which does not verify a traffic light associated with the carriageway and detected in the image data, until such a stop line has been detected in the image data.

### CROSS-REFERENCE TO RELATED APPLICATION

This application claims priority to German Patent Application No. 10 2012 023 867.3, filed Dec. 6, 2012, which is incorporated herein by reference in its entirety.

### TECHNICAL FIELD

The technical field relates to a traffic light detection system for a motor vehicle comprising an optical sensor for recording image data of an environment lying ahead of the motor vehicle as well as an evaluation device for detecting a traffic light mapped in the image data. Furthermore the technical field relates to a motor vehicle with such a traffic light detection system and a method for traffic light detection.

### BACKGROUND

Generic traffic light detection systems are known in the art and are utilized, in particular, for driver assistance systems. For example the DE 102 27 221 A1 discloses a monitoring system with at least one camera that records image data of the space outside. These image data are analyzed for a traffic light or traffic sign assistance system, using contour and/or color analysis. Further the DE 10 2006 023 544 A1 has revealed a method for operating a motor vehicle with at least one at least partially automated support function for the driver. Environment data are recorded with a camera and analyzed. As a result of the analysis road markings, traffic lights, pedestrian crossings or vehicle parked on the edge of the road are recorded.

The (traffic) light detection known from the art is based on detecting certain properties of traffic lights in the image data. In particular the image data are searched for edges and circles in order to detect traffic lights. The problem is that edges and circles are found not only at traffic lights but also on many other objects in an urban environment. Known traffic light detection systems therefore suffer from the problem that they frequently detect traffic lights where there are none. These cases are described as false-positive (FP).

It is at least one object to provide a traffic light detection system that reduces false-positive detections of traffic lights and which thus increases the reliability of modern systems. In addition, other objects, desirable features and characteristics will become apparent from the subsequent summary and detailed description, and the appended claims, taken in conjunction with the accompanying drawings and this background.

### SUMMARY

A traffic light detection system is provided for a motor vehicle comprising an optical sensor for recording image data of an environment lying ahead of the motor vehicle, and an evaluation device for detecting a traffic light mapped in the image data. The traffic light detection system is characterized in that the evaluation device is configured and arranged to detect a stop line in the image data, which is arranged on a carriageway ahead of the motor in a predefined area ahead of the traffic light associated with the carriageway, transversely to the longitudinal direction of the carriageway, in that it comprises a verification device which does not verify a traffic light detected in the image data and associated with the carriageway until such a stop line is detected in the image data, and comprises an output interface, via which the information is provided following successful verification of a traffic light that the traffic light has been verified as such.

At least one inventive aim is to distinctly reduce the number of false-positive detections of traffic lights by additionally searching in the image data for clues to be found typically in the vicinity of traffic lights (mainly a stop line which extends across the carriageway in front of the traffic light), and not verifying a traffic light detected in the image data as a traffic light, until the clues have been detected/are found to be present. Such a stop line on the carriageway to be easily identified in the image data is typically arranged in front of traffic lights on the carriageway.

It is not until such a stop line is detected on a carriageway associated with the detected traffic light that according to the invention the traffic light is verified as a traffic light. As to whether a carriageway with such a stop line is associated with a traffic light detected in the image data is revealed by an evaluation of the layout geometry of a detected traffic light and the carriageway with the stop line with reference to one's own motor vehicle.

An embodiment of the traffic light detection system is characterized in that the information provided via the output interface comprises the following signals: a first signal that is emitted in case a traffic light is detected in the image data, a second signal which is emitted in case of a traffic light is verified as such (by way of image data), and a third signal that is emitted in case a verification of a traffic light is not possible. By emitting these signals it is possible, for example for a driver assistance system connected with the traffic light detection system, to perform, in dependence of the three cases, a reliability evaluation of the result generated by the traffic light detection system, i.e., a traffic light detected in the image data. Thus emission of the second signal, where a traffic light was detected in the image data and has been verified, supplies the information “traffic light was detected” with maximum reliability.

If “only” the first signal is emitted, the reliability of traffic light detection is equal to the methods currently known and used for traffic light detection. If the third signal is emitted, this may mean for example, depending on the respective underlying definition, that for technical reasons no traffic light can be detected (e.g., due to a faulty optical sensor etc.), or for example that a traffic light was detected, albeit, in the image data, a preceding vehicle was also detected in the image data which may hide the stop line on the carriageway. These and other additional output possibilities easily accessible to the expert are used, in particular, to activate downstream assistance systems in the motor vehicle.

The area lying in longitudinal direction of the carriageway ahead of the traffic light preferably comprises an extension of approximately 2 m to approximately 50 m, in particular approximately 3 m, approximately 4 m, approximately 5 m, approximately 6 m, approximately 7 m, approximately 8 m, approximately 9 m, approximately 10 m, approximately 20 m, approximately 30 m or approximately 40 m in carriageway longitudinal direction and an extension transversely to the carriageway longitudinal direction, which at least comprises the width of the lane. These details refer, of course, to dimensions in reality. The evaluation device would therefore preferably search only in that area of the image data for stop lines, which reflect that area in reality.

An embodiment of the traffic light detection system is characterized in that the evaluation device is configured and adapted to determine, in the image data, a preceding vehicle or a stationary vehicle on the carriageway. In this variant therefore a vehicle driving ahead in the same driving lane is determined by analyzing existing image data.

Alternatively or additionally a sensor unit connected with the verification device for determining a preceding vehicle or a stationary vehicle ahead of the motor vehicle may be present, which to this end scans an environment lying ahead of the motor vehicle. In this variant a preceding vehicle is determined with an additional sensor unit scanning the environment lying ahead of the vehicle. Such a sensor unit preferably comprises an ultrasound, radar and/or LIDAR sensor and/or a camera.

An embodiment of the traffic light detection system is characterized in that the verification device is configured and adapted such that if a traffic light associated with the carriageway and a preceding vehicle or a stationary vehicle ahead of the traffic light and ahead of the motor vehicle have been detected, the third signal is emitted. In this case, as already described above, an information is ultimately provided through emitting the third signal, which permits evaluation of the analysis result, which could influence a downstream driver assistance system.

A method-related embodiment is met by a method for traffic light detection, where in a first step using an optical sensor image data of an environment lying ahead of the motor vehicle is recorded and where in a second step a mapped traffic light is identified in the image data using an evaluation device.

According to an embodiment the second step comprises the following steps. In a first step a stop line is identified in the image data, which is arranged on a carriageway lying ahead of the motor vehicle, within a predefined area ahead of a traffic light associated with the carriageway, transversely to the carriageway longitudinal direction. In a further step a traffic light associated with the carriageway and detected in the image data is not verified until such a stop line has been detected in the image data. In a further step, following a successful verification of a traffic light, the information is provided that the traffic light as such has been verified.

An embodiment of the method is characterized in that the following signals are emitted via an output interface connected with the evaluation device: a first signal in the case a traffic light has been detected in the image data, a second signal in the case such a traffic light has been verified by way of the image data, and/or a third signal in the case a verification of a traffic light is not possible.

An embodiment of the method is characterized in that the evaluation device is configured and adapted to identify a preceding vehicle or a stationary vehicle on the carriageway in the image data. Alternatively or additionally a sensor unit connected with the verification device for determining a preceding vehicle or a stationary vehicle ahead of the motor vehicle may be present which to this end scans an environment lying ahead of the motor vehicle. Another embodiment of the method is characterized in that, provided a traffic light associated with the carriageway and a preceding vehicle or a stationary vehicle ahead of the traffic light have been detected in the image data, the third signal is emitted.

The embodiments provide analogously transcribing the above statements in relation to the traffic light detection system and its further developments.

Finally, a motor vehicle is equipped with an above-described traffic light detection system according to an embodiment.

### BRIEF DESCRIPTION OF THE DRAWINGS

The present invention will hereinafter be described in conjunction with the following drawing figures, wherein like numerals denote like elements, and:

FIG. 1 shows a typical scene at a road intersection;

FIG. 2 shows a schematic flow diagram depicting the process steps of the method according to an embodiment; and

FIG. 3 shows a schematic diagram of the structure of a traffic light detection system according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

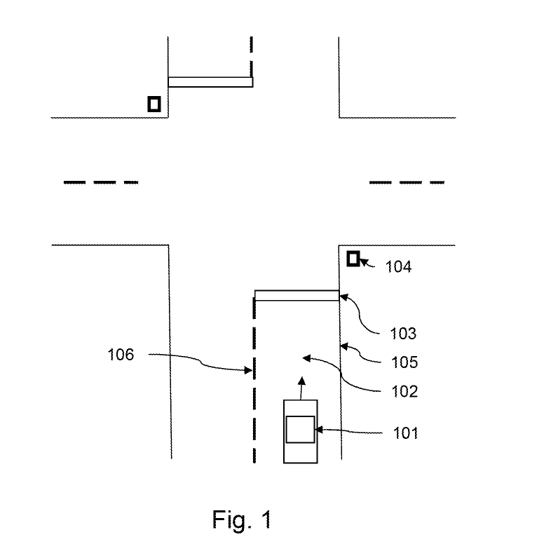

FIG. 1 shows a typical scene at a road intersection for use in explaining the embodiments. In this scene a motor vehicle 101 equipped with a traffic light detection system approaches an intersection on a carriageway 102. The carriageway 102 is laterally limited by a dashed line 106 marking the center of the road and a road edge 105. A traffic light 104 is positioned at the intersection and this is associated with the carriageway. Further, on the carriageway 102 ahead of the motor vehicle 101 a stop line 103 is arranged transversely to the carriageway longitudinal direction in the area ahead of a traffic light 104 associated with the carriageway 102.

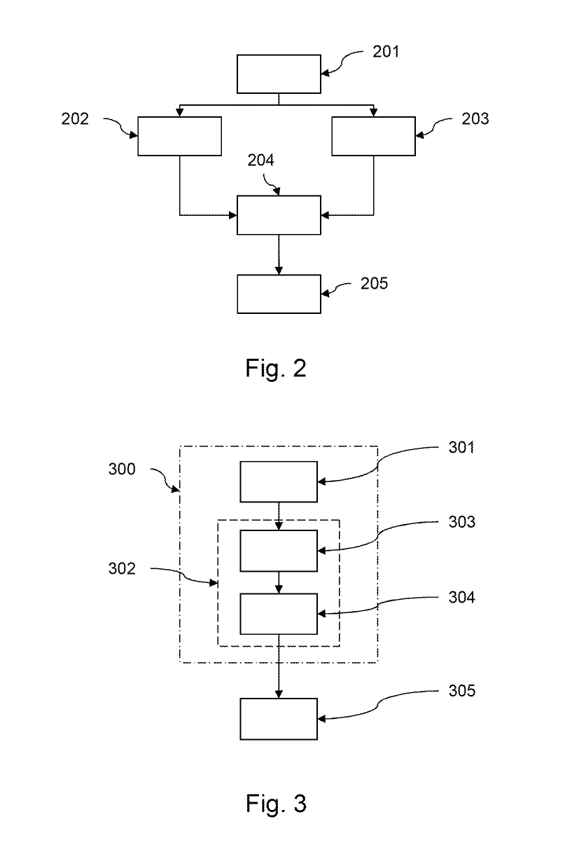

FIG. 2 shows a schematic flow diagram of the procedure employed in the method for traffic light detection. A first step 201 image data of the environment ahead of the motor vehicle are recorded by an optical sensor, and in a second step, using an evaluation device, a traffic light mapped in the image data is determined In parallel or subsequently thereto, in a third step 203, a stop line 103 is determined in the image data that is arranged on a carriageway 102 ahead of the motor vehicle 101 in a predefined area ahead of a traffic light 104 associated with the carriageway 102, transversely to the carriageway longitudinal direction. If both the traffic light 104 and the associated stop line 103 are determined in the image data, then the traffic light 104 associated with the carriageway 102 and detected in the image data is verified in a fourth step 204. In a fifth step 205, following successful verification of the traffic light 104, the information is provided that the traffic light 104 has been verified as such.

FIG. 3 shows a schematic diagram of the structure of the traffic light detection system of motor vehicle 101, comprising an optical sensor 301 for recording image data of an environment lying ahead of the motor vehicle 101, and an evaluation device 302 for detecting a traffic light mapped in the image data. The evaluation device 302 is configured and adapted to recognize a stop line 103 in the image data, which is arranged on a carriageway 102 ahead of the motor vehicle 101 in a predefined area ahead of a traffic light 104 associated with the carriageway 102. The evaluation device 302 comprises a verification device 303 that does not verify the traffic light 104 associated with the carriageway and detected in the image data as being a traffic light, until such a stop line 103 has been detected in the image data. The evaluation device 302 further comprises an output interface 304, via which following successful verification of a traffic light 104 the information is provided that the traffic light 104 has been verified as such in the image data. This information is provided to a driver assistance system 305.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary ad detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A traffic light detection system for a motor vehicle, comprising:
an optical sensor that is configured to record image data of an environment ahead of the motor vehicle;
an evaluation device that is configured to recognize a traffic light mapped in the image data, the evaluation device is configured to detect a stop line in the image data, which is arranged on a carriageway that is ahead of the motor vehicle in an area that is ahead of the traffic light associated with the carriageway, transversely to a carriageway longitudinal direction;
a verification device that is configured to verify the traffic light detected in the image data and associated with the carriageway until such a stop line is detected in the image data; and
an output interface that is configured to provide information that the traffic light has been verified following successful verification of the traffic light.

2. The traffic light detection system according to claim 1,
wherein a plurality of signals are provided via the output interface, the plurality of signals comprising:
a first signal that is emitted in case a traffic light is detected in the image data;
a second signal that is emitted in case a verification of the traffic light; and
a third signal that is emitted in case the verification of the traffic light is net unavailable.

3. The traffic light detection system according to claim 1,
wherein the area in a carriageway longitudinal direction ahead of the traffic light comprises an extension between approximately 2 m and approximately 5 m in the carriageway longitudinal direction, and an extension transversely to the carriageway longitudinal direction that is at least as wide as the a driving lane.

4. The traffic light detection system according to claim 1, wherein the evaluation device is configured to determine a vehicle , in the image data, on the carriageway.

5. The traffic light detection system according to claim 1, further comprising a sensor unit connected to the verification device that is configured to identify a presence of a vehicle, which scans the environment ahead of the motor vehicle.

6. The traffic light detection system according to claim 5, wherein the sensor unit comprises an ultrasound.

7. The traffic light detection system according to claim 2,
wherein the evaluation device is configured to emit the third signal via the output interface if a traffic light associated with the carriageway and a vehicle ahead of the motor vehicle and ahead of the traffic light is detected.

8. A method for traffic light detection comprising:
determining in image data a stop line arranged on a carriageway of a motor vehicle with an evaluation device, in an area that is ahead of the traffic light associated with the carriageway, transversely to a carriageway longitudinal direction;
verifying the traffic light detected in the image data and associated with the carriageway after the stop line is detected in the image data; and
providing information that the traffic light has been verified following successful verification of a traffic light.

9. The method according to claim 8, further comprising:
providing a first signal in case the traffic light has been detected in the image data;
providing a second signal in case the traffic light has been verified; and
providing a third signal in case verification of the traffic light is not possible.

10. The method according to claim 8, wherein the area arranged in the carriageway longitudinal direction that is ahead of the traffic light comprises an extension between approximately 2 m and approximately 50 m, in the carriageway longitudinal direction and an extension transversely to the carriageway longitudinal direction, that is at least a width of a driving lane.

11. The method according to claim 8, determining with the evaluation device a vehicle on the carriageway in the image data.

12. The method according to claim 8,
further comprising scanning with a sensor unit connected to a verification device to determine an environment ahead of the motor vehicle is present.

13. The method according to claim 9,
further comprising emitting the third signal if the traffic light associated with the carriageway and a vehicle is detected in the image data.

14. (canceled)

15. The traffic light detection system according to claim 1, wherein the area in a carriageway longitudinal direction ahead of the traffic light comprises an extension between approximately 5 m or 10 m in the carriageway longitudinal direction, and an extension transversely to the carriageway longitudinal direction which is at least as wide as a driving lane.
